(19) United States
(12) Patent Application Publication
(10) Pub. No.: US 2021/0228019 A1
(43) Pub. Date: Jul. 29, 2021

(54) Beverage Maker And Method For Operating A Beverage Maker

(71) Applicant: WMF Group GMBH, Geislingen (steige) (DE)

(72) Inventors: Peter Arndt, Blaustein (DE); Frank Göltenboth, Senden (DE); Armin Startz, Weidenstetten (DE)

(73) Assignee: WMF Group GMBH, Geislingen (steige) (DE)

(21) Appl. No.: 17/050,976

(22) PCT Filed: Apr. 26, 2019
(86) PCT No.: PCT/EP2019/060756

§ 371 Date: Oct. 27, 2020

(30) Foreign Application Priority Data
Apr. 27, 2018 (DE) 10 2018 206 565.9

(51) Int. Cl. A47J 31/52; A47J 31/44

(52) U.S. Cl. CPC A47J 31/521; G07F 13/065; A47J 31/4403

(57) ABSTRACT

A beverage maker which comprises a graphic user interface, a control unit and a data memory is presented. The control unit is configured to use a selection of at least one element in respectively at least two groups of elements for a decision as to which drink is dispensed by the beverage maker and is configured, on the basis of a selection of at least one element in the first group by a user and on the basis of a matrix stored in the data memory, to determine whether the display of one or more element(s) of a second group of elements on the graphic user interface is changed. Correspondingly, a method for operating a beverage maker is presented. The beverage maker and the method for operating a beverage maker allow a user of the beverage maker a more effortless, more error-free and faster selection and dispensing of a drink desired by him.

### BACKGROUND OF THE INVENTION

A beverage maker which comprises a graphic user interface, a control unit and a data memory is presented. The control unit is configured to use a selection of at least one element in respectively at least two groups of elements for a decision as to which drink is dispensed by the beverage maker and is configured, on the basis of a selection of at least one element in the first group by a user and on the basis of a matrix stored in the data memory, to determine whether the display of one or more element(s) of a second group of elements on the graphic user interface is changed. Correspondingly, a method for operating a beverage maker is presented. The beverage maker and the method for operating a beverage maker allow a user of the beverage maker a more effortless, more error-free and faster selection and dispensing of a drink desired by him.

A device for a coffee machine is known from WO 2011/046428 A1, with which elements (or recipe ingredients) displayed by means of a touch display can be marked and/or can be drawn into a selection field. The marked elements are either removed from the selection field and displayed in the preview field or highlighted optically correspondingly. Hence, a decision can be made about the composition of the drink step by step. The sequence of the selection of the components can thereby be arbitrary. In the case where the decision is intended to be corrected, the remaining contents of the individual selection fields remain active.

A device is known from EP 2 945 514 A1, in which the drink is composed (configured) in a selection region and the selected result is displayed in a preview region at the same time. After activating a start button, the drink displayed in the preview region is dispensed. There is a selection mode with partially graphic display, a plurality of drinks variants being displayed. After selection of a drinks variant by the user, the drink is dispensed.

In the case of many possible recipe combination possibilities, in general “preselect” methods or “postselect” methods are known.

In the case of the “preselect” method, additional components of the drink are selected at the beginning and then preparation of the product is started via the drinks button (e.g. espresso or café crème). In the case of the “postselect” method, the main drink is chosen first (e.g. coffee) and then, in further inquiry steps, possible further ingredients are selected (e.g. the desired cup size, strength, sugar, etc.). Therefore in the case of this selection method, a strictly specified selection sequence must always be run through before the drink can be dispensed. This can be very time-intensive.

The “preselect” method offers, relative to the “postselect” method, the advantage that the entire selection structure need not be run through if no further ingredients or adjustments are desired. For example, in the “preselect” method, the selection “black coffee without sugar and with milk” can be effected directly with one keypress. A disadvantage of the “preselect” method is however that, for a selection of the additionally desired adjustments, typically all options must be displayed on a screen. Furthermore, the user of the beverage maker possibly cannot detect all selection possibilities due to the large number of displayed selection possibilities and possibly inadvertently triggers an undesired drink.

Starting herefrom, it was the object of the present invention to provide a beverage maker and a method for operating a beverage maker which allows a user a more effortless and faster selection of a desired product and reduces the probability of user errors.

The object is achieved by the beverage maker having the features of claim 1 and the method having the features of claim 8. The dependent claims reveal advantageous developments.

According to the invention, a beverage maker is provided, comprising
a) a graphic user interface which is configured
   to display a first group of elements relating to a first parameter of a drink and to allow a user to select therefrom; and
   at least one second group of elements relating to at least one second parameter of a drink and to allow a user to select therefrom;
   the at least one second parameter being different from the first parameter;
b) a control unit which is configured to use a selection of at least one element in the first group and a selection of at least one element in the at least one second group for a decision as to which drink is dispensed by the beverage maker; and
c) a data memory in which a matrix is stored, which matrix comprises information about whether an element of the first group has a connection to an element of the at least one second group;

characterised in that the control unit is configured, on the basis of a selection of at least one element in the first group and on the basis of the matrix stored in the data memory, to determine whether the display of at least one element of the at least one second group on the graphic user interface is changed (e.g. is highlighted, is moved into the background or is not displayed).

The beverage maker makes the display of the element of the second group dependent upon the selection of an element of the first group and allows the user hence a more effortless and faster selection of “his” product since not all possibilities (elements) of the second group attract the attention of the user but merely a relevant partial range thereof is moved into the focus of the user. In other words, non-combinable possibilities move into the background or are faded out completely and hence the probability of the user making an operating error is also reduced (e.g. avoidance of simultaneous selection of drink type espresso and the selection of milk).

The advantage emerges therefrom that, even with a large number of displayed selection possibilities, a gradual simplification takes place and hence an effortless, clear and fast operation of the beverage maker becomes possible. The beverage maker hence opens up the possibility of an efficient, fast and individual selection of a drink to be dispensed.

The beverage maker can be configured to allow a user to specify which elements of the first group (relating to a first parameter of a drink) are displayed on the graphic user interface, i.e. which elements of the first group are allowed at all for the selection. Consequently, the graphic user interface displays for the user also only this selection of elements of the first group in order to make his selection in this (limited) group. Such a restriction can be advantageous above all in self-service operation (“self-service operation”) in order further to simplify operation of the beverage maker and to enable preparation of a drink for the user more effortlessly and faster.

Furthermore, the beverage maker can be configured such that the changed display of the at least one element of the at least one second group is such that the at least one element is no longer selectable (and hence the previously activated selection is to be understood as prioritised or set choice) or the at least one element continues to be selectable (and hence possibly to cancel again the previously chosen conditions or to open up again anew the possibilities permissible for the just activated selection).

In a preferred embodiment, the graphic user interface is configured to display at least one third group of elements relating to at least one third parameter of a drink and to allow the user to select therefrom, the at least one third parameter being different from the first and second parameter. In this embodiment, the control unit is configured to use a selection of at least one element in the first group, a selection of at least one element in the second group and a selection of at least one element in the third group for a decision as to which drink is dispensed by the beverage maker. Furthermore, a matrix is stored in the data memory, which matrix comprises information about whether an element of the first group has a connection to an element of the second group and whether an element of the second group has a connection to an element of the third group. The control unit is configured, on the basis of a selection of at least one element in the first group, on the basis of a selection of at least one element in the second group and on the basis of the matrix stored in the data memory, to determine whether the display of at least one element of the at least one third group on the graphic user interface is changed (e.g. is highlighted, is moved into the background or is not displayed).

Furthermore, embodiments are preferred in which the graphic user interface is configured to display at least one fourth and/or further group of elements relating to at least one fourth and/or further parameter of a drink and to allow a user to select therefrom, the at least one fourth and/or further parameter being different from the other parameters (i.e. all the parameters are different). The matrix comprises correspondingly information about the connections of the elements between the individual groups. The configuration of the control unit corresponds to the configuration of the control unit described in the preceding paragraph, with the difference that now at least one fourth and/or further group of elements is taken into account by the control unit for determining the display on the graphic user interface.

The beverage maker can be characterised in that the first and/or second parameter of the drink is selected from the group consisting of
i) drink type (by way of example elements of the group of this parameter: cappuccino, espresso, latte-macchiato);
ii) drink size (by way of example elements of the group of this parameter: small, medium or large;
iii) drink preparation type (by way of example elements of the group of this parameter: American style, cold brew, French press);
iv) user type (by way of example elements of the group of this parameter: adult, child, vegan);
v) user preferences (by way of example elements of the group of this parameter: vegan drink, lactose-free drink);
vi) ingredient (by way of example elements of the group of this parameter: without milk, normal milk, low-fat milk, low-lactose milk, sugar, syrup);
vii) drink price (by way of example elements of the group of this parameter: minimum price, maximum price, price range);
viii) country selection (by way of example elements of the group of this parameter: Switzerland); and
ix) menu language (by way of example elements of the group of this parameter: German, Italian, French).

The selection sequence is hereby left to the user himself. It is therefore left up to the user whether he selects the ingredient for example as first parameter for his drink and only then the type of drink as second parameter, or vice versa. By selecting a specific country and/or a specific menu language as first parameter, categorisation of user preferences can be made in at least one second group of elements. In this case, the user preferences are the second parameter of the drink and, in the displayed group of elements, at least one element on the graphic user interface of the beverage maker is changed. In the case of a selection of a specific price range (=first group of elements), for example the display of specific drink types (=second group of elements) is changed, which elements do not lie within the desired price range (e.g. these drink types are placed in the background).

Furthermore, the graphic user interface can be configured to make a simultaneous selection of a plurality of elements of one group (e.g. by sweeping over these displayed elements by a user). This is advantageous, e.g. in the case of size details or price details. A user can thereby place a finger on the user interface and move over the desired region with the elements without removing the finger. When the finger is removed, the individual elements of the region are hence selected.

In a preferred embodiment of the beverage maker, the beverage maker is configured to display via the graphic user interface a preview of a price to be paid for the selected drink.

The graphic user interface of the beverage maker can be configured to display the elements of the first group of elements and/or the elements of the at least one second group of elements via selection fields, preferably via selection fields which display the elements in at least one specific form, preferably a form selected from the group consisting of word(s), number(s), symbol(s) and combinations hereof, particularly preferably in a pictogram.

Furthermore, the selection fields can display the elements in at least one specific arrangement, preferably an arrangement selected from the group consisting of slide bar, scroll wheel, individual keys, lists and combinations hereof. The arrangement of the elements via a slide bar and/or a scroll wheel is particularly advantageous if the number of elements of the group exceeds the possible space available on the graphic user interface. The arrangement via a slide bar and/or a scroll wheel makes it possible to display a virtually infinite number of elements of one group on the smallest space via the graphic user interface. In particular, number sequences for pricing or size details can be displayed clearly and simply via this arrangement

The graphic user interface can be configured to display a trigger field for preparing a drink and to allow a user to select it, preferably a trigger field which comprises at least
i) a word; and/or
ii) a button symbol, preferably a start button symbol; and/or
iii) a symbol of a drink selected by the user;

or consists thereof. The trigger field is preferably configured (or is controlled via the graphic user interface), after activation by a user (e.g. after selection of a word, a button symbol and/or a symbol of a selected drink in the trigger field by a user), to change its content and/or to send a signal (e.g. an optical, acoustic and/or haptic signal).

In a preferred embodiment, dispensing of the drink by the beverage maker is started by activation of the trigger field (e.g. activation button and/or trigger button as button symbol). The graphic user interface can be configured to fade the trigger field in from a time after which the drink to be dispensed is unequivocally established. The graphic user interface is optionally configured to display the selected drink in the trigger field (e.g. as pictogram).

The control unit of the beverage maker can be configured to store a selection of at least one element in the first group in the data memory such that the selection is preselected after switching off and switching on of the beverage maker, and the display of at least one element of the at least one second group on the graphic user interface is determined, for this purpose the first parameter being selected preferably from the group consisting of country selection, language selection and combinations hereof.

Furthermore, the control unit can be configured to use a selection of at least one element in the first group and a selection of at least one element in the at least one second group for the purpose of storing a favourites matrix in the data memory, which matrix comprises information about whether an element of the first group has a connection to an element of the at least one second group which is preferred by a user. Preferably, the control unit is configured, on the basis of a selection of at least one element in the first group and in addition on the basis of the favourites matrix stored in the data memory, to determine whether the display of at least one element of the at least one second group on the graphic user interface is changed (e.g. is highlighted, is moved into the background or is not displayed).

In a preferred embodiment, the control unit is configured to move into the background and/or to highlight the display of at least one element of the at least one second group on the graphic user interface via a change selected from the group consisting of
i) inverse display, greying out, fading out, reducing in size and combinations hereof; and/or
ii) underlined display, colouring, enlarging and combinations hereof.

Furthermore, according to the invention, a method is provided for operating a beverage maker, the method comprising the steps of
a) display on a graphic user interface of a beverage maker and possibility for selection therefrom by a user;
   a first group of elements relating to a first parameter of a drink; and
   at least one second group of elements relating to at least one second parameter of a drink;
   the at least one second parameter being different from the first parameter;
b) use, by a control unit of the beverage maker, of a selection of at least one element in the first group and of a selection of at least one element in the at least one second group for a decision as to which drink is dispensed by the beverage maker, and
c) determination, by the control unit of the beverage maker, on the basis of a selection of at least one element in the first group and on the basis of a matrix stored in the data memory of the beverage maker, of whether the display of at least one element of the at least one second group on the graphic user interface is changed (e.g. is highlighted, is moved into the background or is not displayed), the matrix comprising information about whether an element of the first group has a connection to an element of the at least one second group.

In a preferred embodiment of the method, the beverage maker allows a user to specify which elements of the first group (relating to a first parameter of a drink) are displayed on the graphic user interface, i.e. which elements of the first group are allowed at all for the selection. Consequently, the graphic user interface displays for the user also only this selection of elements of the first group in order to make his choice in this (limited) group. Such a restriction can be advantageous above all in self-service operation (“self-service operation”) in order further to simplify operation of the beverage maker and to enable preparation of a drink for the user more effortlessly and faster.

In the method, the changed display of the at least one element of the at least one second group can be such that the at least one element is no longer selectable (and hence the previously activated selection is to be understood as prioritised or set choice) or the at least one element continues to be selectable (and hence possibly to cancel again the previously selected conditions or to open up again anew the possibilities permissible for the just activated selection).

In a preferred embodiment of the method, the graphic user interface displays at least one third group of elements relating to at least one third parameter of a drink and allows the user to select therefrom, the at least one third parameter being different from the first and second parameter. In this embodiment, the control unit uses a selection of at least one element in the first group, a selection of at least one element in the second group and a selection of at least one element in the third group for a decision as to which drink is dispensed by the beverage maker. Furthermore, the matrix of the data memory comprises information about whether an element of the first group has a connection to an element of the second group and whether an element of the second group has a connection to an element of the third group. The control unit, on the basis of a selection of at least one element in the first group, on the basis of a selection of at least one element in the second group and on the basis of the matrix stored in the data memory, determines whether the display of at least one element of the at least one third group on the graphic user interface is changed (e.g. is highlighted, is moved into the background or is not displayed).

Furthermore, embodiments are preferred in which the graphic user interface displays at least one fourth and/or further group of elements relating to at least one fourth and/or further parameter of a drink and allows a user to select therefrom, the at least one fourth and/or further parameter being different from the other parameters (i.e. all the parameters are different). The matrix correspondingly comprises information about the connections of the elements between the individual groups. The consideration made by the control unit corresponds to that described in the preceding paragraph, with the difference that now at least one fourth and/or further group of elements is taken into account by the control unit for determining the display on the graphic user interface.

In the method according to the invention, the first and/or second parameter of the drink can be selected from the group consisting of
i) drink type (by way of example elements of the group of this parameter: cappuccino, espresso, latte-macchiato);
ii) drink size (by way of example elements of the group of this parameter: small, medium or large);
iii) drink preparation type (by way of example elements of the group of this parameter: American style, cold brew, French press);
iv) user type (by way of example elements of the group of this parameter: adult, child, vegan);
v) user preferences (by way of example elements of the group of this parameter: vegan drink, lactose-free drink);
vi) ingredient (by way of example elements of the group of this parameter: without milk, normal milk, low-fat milk, low-lactose milk, sugar, syrup);
vii) drink price (by way of example elements of the group of this parameter: minimum price, maximum price, price range);
viii) country selection (by way of example elements of the group of this parameter: Switzerland); and
ix) menu language (by way of example elements of the group of this parameter: German, Italian, French).

The selection sequence is hereby left to the user himself. It is therefore left up to the user whether he selects the ingredient for example as first parameter for his drink and only then the type of drink as second parameter, or vice versa. By selecting a specific country and/or a specific menu language as first parameter, categorisation of user preferences can be made in at least one second group of elements. In this case, the user preferences are the second parameter of the drink and, in the displayed group of elements, at least one element on the graphic user interface of the beverage maker is changed. In the case of a selection of a specific price range (=first group of elements), for example the display of specific drink types (=second group of elements) is changed, which elements do not lie within the desired price range (e.g. these drink types are placed in the background).

Furthermore, in a preferred embodiment of the method, a simultaneous selection of a plurality of elements of one group can be made via the graphic user interface (e.g. by sweeping over these displayed elements by a user). This is advantageous, e.g. in the case of size details or price details. A user can thereby place a finger on the user interface and move over the desired region with the elements without removing the finger. When the finger is removed, the individual elements of the region are hence selected.

In a further preferred embodiment of the method, the beverage maker displays a preview of a price to be paid for the selected drink on the graphic user interface.

In the method, the elements of the first group of elements and/or the elements of the at least one second group of elements can be displayed on the graphic user interface via selection fields, preferably via selection fields which display the elements in at least one specific form, preferably a form selected from the group consisting of word(s), number(s), symbol(s) and combinations hereof, particularly preferably in a pictogram. Furthermore, the elements of the selection fields can be displayed in at least one specific arrangement, preferably an arrangement selected from the group consisting of slide bar, scroll wheel, individual keys, lists and combinations hereof.

In the method, a trigger field for preparing a drink can be displayed on the graphic user interface and allow a user to select it, preferably a trigger field which comprises at least
i) a word; and/or
ii) a button symbol, preferably a start button symbol; and/or
iii) a symbol of a drink selected by the user;

or consists thereof. The trigger field is preferably configured (or is controlled via the graphic user interface), after activation by a user (e.g. after selection of a word, a button symbol and/or a symbol of a selected drink in the trigger field by a user), to change its content and/or to send a signal (e.g. an optical, acoustic and/or haptic signal).

Dispensing of the drink by the beverage maker can be started by activation of the trigger field (e.g. activation button and/or trigger button as button symbol). For this purpose, the trigger field can be faded in via the graphic user interface from a time after which the drink to be dispensed is unequivocally established. The graphic user interface optionally displays the selected drink in the trigger field (e.g. as pictogram).

In one possible embodiment, a selection of at least one element in the first group is stored in the data memory via the control unit of the beverage maker such that the selection is preselected after switching off and switching on of the beverage maker, and the display of at least one element of the at least one second group on the graphic user interface is determined, for this purpose the first parameter being hereby selected preferably from the group consisting of country selection, language selection and combinations hereof. The user can in this case start from a selection in the at least one second group of elements (e.g. in the group “drink type” or “price”), said selection being able to change the display of at least one element of at least one third group of elements (e.g. an element of the group “milk” or “sugar”) on the graphic user interface.

Via the control unit of the beverage maker, a selection made by the user of at least one element in the first group and a selection of at least one element in the at least one second group can be used for the purpose of storing a favourites matrix in the data memory, which matrix comprises information about whether an element of the first group has a connection preferred by a user to an element of the at least one second group. Preferably, via the control unit of the beverage maker, on the basis of a selection of at least one element in the first group and in addition on the basis of the favourites matrix stored in the data memory, it can be determined whether the display of at least one element of the at least one second group on the graphic user interface is changed (e.g. is highlighted, is moved into the background or is not displayed).

Via the control unit of the beverage maker, furthermore the display of at least one element of the at least one second group on the graphic user interface can be moved into the background and/or highlighted via a change selected from the group consisting of
i) inverse display, greying out, fading out, reducing in size and combinations hereof;

and/or
ii) underlined display, colouring, enlarging and combinations hereof.

The subject according to the invention is intended to be explained in more detail with reference to the subsequent examples and Figures without wishing to restrict said subject to the specific embodiments illustrated here.

### BRIEF DESCRIPTION OF THE DRAWINGS

FIG. 1 shows a view on a graphic user interface 1 of a beverage maker according to the invention. The first group 2 of elements 2′ relating to the parameter “country selection” is displayed in the selection field 8 at the upper edge of the graphic user interface 1. A second group 3 of elements 3′ relating to the parameter “type” (=drink type) is displayed in the selection field 8^{I} which is situated on the left on the graphic user interface 1. A third group 4 of elements 4′ relating to the parameter “size” (=drink size) is displayed in a further selection field 8^{II} on the graphic user interface 1. In the centre of the graphic user interface 1, a fourth group 5 of elements 5′ relating to the parameter “milk” is displayed in a further selection field 8^{III}. From the centre of the graphic user interface 1 to the right-hand edge of the graphic user interface 1 there is situated a further selection field 8^{IV} in which a fifth group 6 of elements 6′ relating to the parameter “sugar” is displayed and a further selection field 8^{V} in which a sixth group 7 of elements 7′ relating to the parameter “price” is displayed. At the outermost right-hand edge of the graphic user interface 1, a trigger field 9 in the form of a trigger button is displayed.

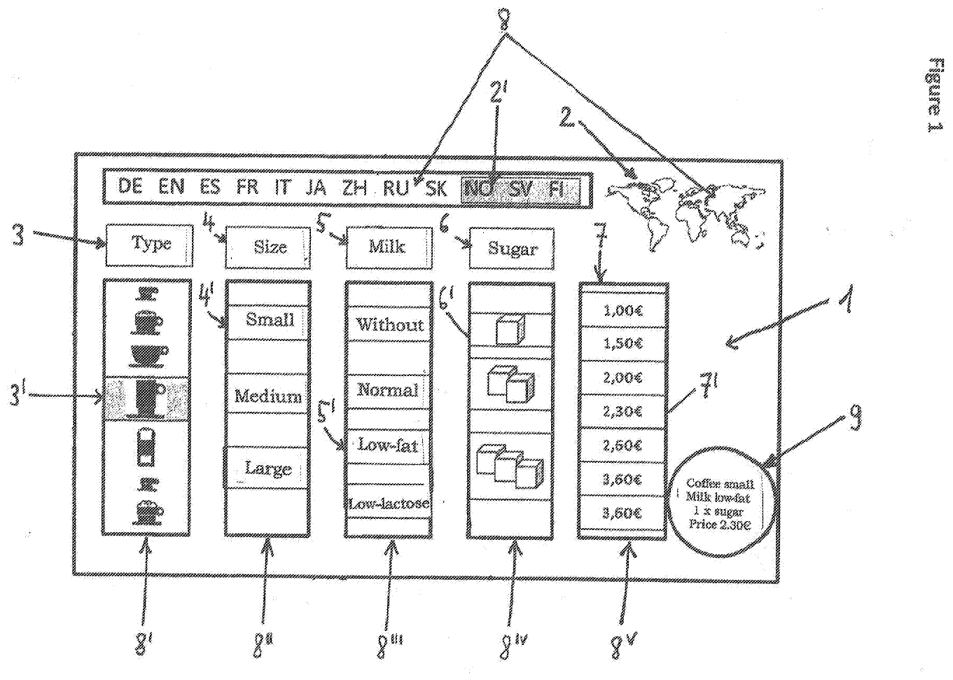

FIG. 2 shows an illustration of a first group 2 of elements 2′ relating to a first parameter of a drink, the group 2 concerning regions/countries of the earth and the elements 2′ of the group displaying the individual regions or countries of the earth (here: South America).

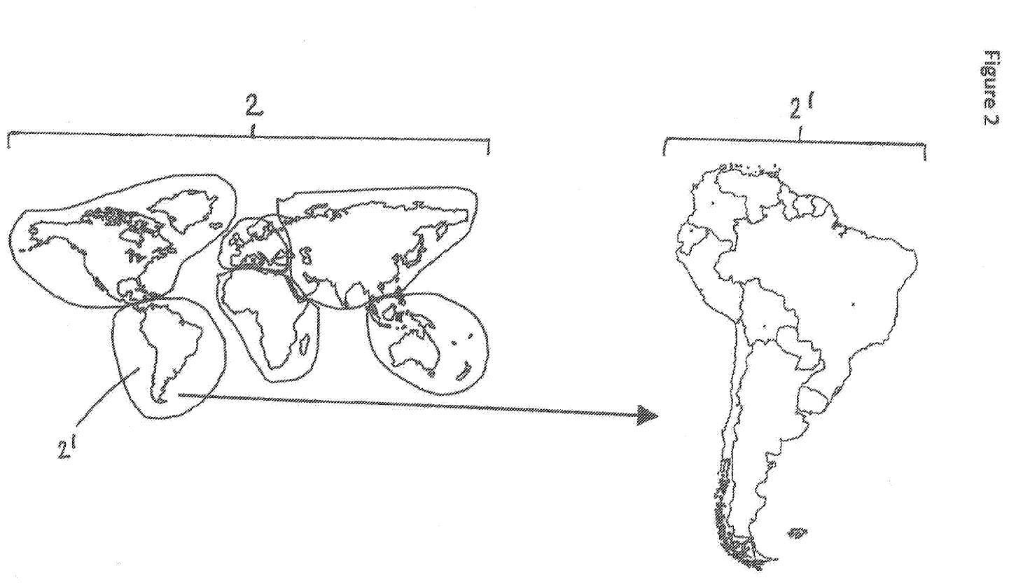

FIG. 3 shows a matrix as can be stored in a data memory of a beverage maker according to the invention. The matrix comprises information about whether the elements of the various groups have respectively a connection to each other.

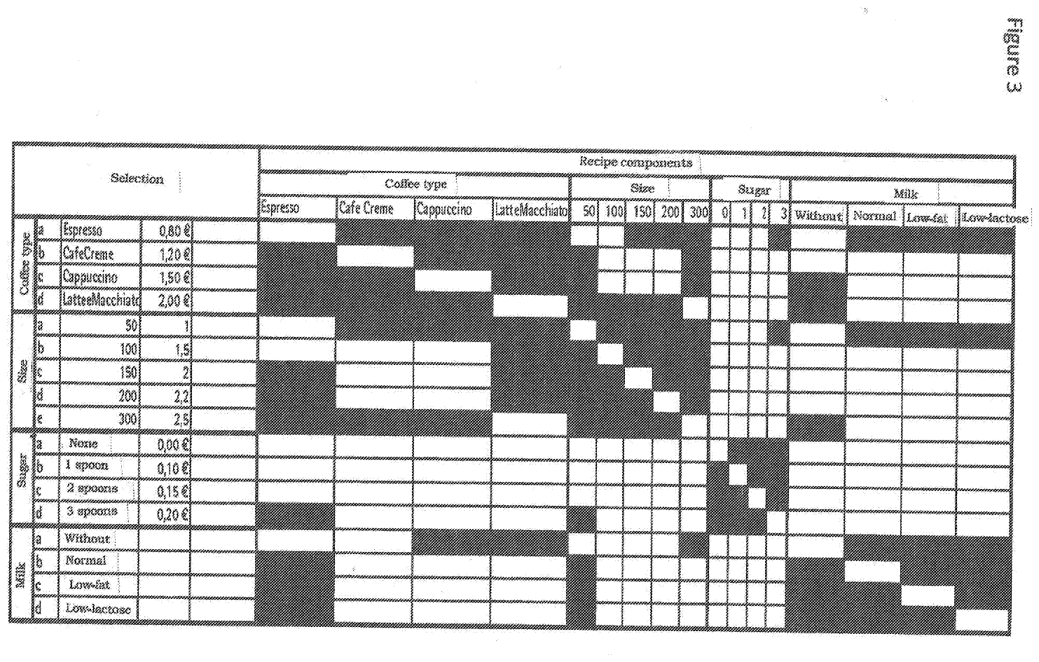

### EXAMPLE 1

### Selection of an Espresso Via the Beverage Maker

In the selection of an espresso in the first group “drink type” on the graphic user interface of the beverage maker, all the selection possibilities for various milk sorts in the second group “ingredient” are placed in the background as a consequence hereof since an espresso is not prepared with milk. This information is encoded in the matrix in the data memory of the beverage maker since, in this matrix, no connection exists between an “espresso” (=element of the group “drink type”) and the different possible milk types (=elements of the group “ingredient”).

### EXAMPLE 2

### Selection of the Ingredient “Low-Fat Milk” Via the Beverage Maker

In the selection of the ingredient “low-fat milk” on the graphic user interface of the beverage maker, the selection of the drink type “espresso” is placed in the background as a consequence hereof since an espresso is not prepared with milk. This information is encoded in the matrix in the data memory of the beverage maker since, in this matrix, no connection exists between “low-fat milk” (=element of the group “ingredient”) and an espresso (=element of the group “drink type”).

### EXAMPLE 3

### Selective Display for Specific User Groups

In order for example to achieve a selective display for specific user groups, the graphic user interface can be configured to display a map (=first group of elements) in order to enable a rapid change in language selection or in the regionally preferred drinks. After activating the country selection, the display of the elements of the further groups is adapted correspondingly on the user interface. A multistep selection process is also possible. For example after selecting South America on the world map, a zoom to the continent is thereby displayed, with which the further selection of the target country (e.g. Brazil) is possible. Hence, the screen contents (in particular texts and/or regional or country-specific symbols) of the selection are adapted according to this choice.

### REFERENCE NUMBER LIST

1: graphic user interface (e.g. touch screen);

2: 1^{st} group of elements (e.g. regions/countries of the earth);

2′: element of the 1st group (e.g. Scandinavia or South America);

3: 2^{nd} group of elements (e.g. drink type);

3′: element of the 2^{nd} group (e.g. coffee);

4: 3^{rd} group of elements (e.g. size);

4′: element of the 3^{rd} group (e.g. small);

5: 4^{th} group of elements (e.g. milk);

5′: element of the 4^{th} group (e.g. low-fat milk);

6: 5^{th} group of elements (e.g. sugar);

6′: element of the 5^{th} group (e.g. 1 portion of sugar);

7: 6^{th} group of elements (e.g. price);

7′: element of the 6^{th} group (e.g. 2.30€);

8, 8^{I}, 8^{II},

8^{III}, 8^{IV}, 8^{V}: selection field for elements of the respective groups;

9: trigger field for preparing a drink.

1. Beverage maker, comprising
a) a graphic user interface which is configured
to display a first group of elements relating to a first parameter of a drink and to allow a user to select therefrom; and
at least one second group of elements relating to at least one second parameter of a drink and to allow a user to select therefrom;
the at least one second parameter being different from the first parameter;
b) a control unit which is configured to use a selection of at least one element in the first group and a selection of at least one element in the at least one second group for a decision as to which drink is dispensed by the beverage maker; and
c) a data memory in which a matrix is stored, which matrix comprises information about whether an element of the first group has a connection to an element of the at least one second group;
wherein the control unit is configured, on the basis of a selection of at least one element in the first group and on the basis of the matrix stored in the data memory, to determine whether the display of at least one element of the at least one second group on the graphic user interface is changed.

2. Beverage maker according to claim 1, wherein the first and/or second parameter of the drink is selected from the group consisting of
i) drink type;
ii) drink size;
iii) drink preparation type;
iv) user type;
v) user preferences;
vi) ingredient;
vii) drink price;
viii) country selection; and
ix) menu language.

3. Beverage maker according to claim 1, wherein the graphic user interface is configured to display the elements of the first group of elements and/or the elements of the at least one second group of elements via selection fields, preferably via selection fields which display the elements
i) in at least one specific form, preferably a form selected from the group consisting of word(s), number(s), symbol(s) and combinations hereof, particularly preferably in a pictogram; and/or
ii) in at least one specific arrangement, preferably an arrangement selected from the group consisting of slide bar, scroll wheel, individual keys, lists and combinations hereof.

4. Beverage maker according to claim 1, wherein the graphic user interface is configured to display a trigger field for preparing a drink and to allow a user to select it, preferably a trigger field which comprises at least
i) a word; and/or
ii) a button symbol, preferably a start button symbol; and/or
iii) a symbol of a drink selected by the user;
or consists thereof, the trigger field being preferably configured, after activation by a user, to change its content and/or to send a signal.

5. Beverage maker according to claim 1, wherein the control unit is configured to store a selection of at least one element in the first group in the data memory such that the selection is preselected after switching off and switching on of the beverage maker, and the display of at least one element of the at least one second group on the graphic user interface is determined, the first parameter being selected preferably for this purpose from the group consisting of country selection, menu language and combinations hereof.

6. Beverage maker according to claim 1, wherein the control unit is configured to use a selection of at least one element in the first group and a selection of at least one element in the at least one second group for the purpose of storing a favourites matrix in the data memory, which matrix comprises information about whether an element of the first group has a connection preferred by a user to an element of the at least one second group and, preferably, the control unit is configured, on the basis of a selection of at least one element in the first group and in addition on the basis of the favourites matrix stored in the data memory, to determine whether the display of at least one element of the at least one second group on the graphic user interface is highlighted or is moved into the background.

7. Beverage maker according to claim 1, wherein the control unit is configured to move into the background and/or to highlight the display of at least one element of the at least one second group on the graphic user interface via a change selected from the group consisting of
i) inverse display, greying out, fading out, reducing in size and combinations hereof; and/or
ii) underlined display, colouring, enlarging and combinations hereof.

8. Method for operating a beverage maker, comprising the steps of
a) display on a graphic user interface of a beverage maker and possibility for selection therefrom by a user:
a first group of elements relating to a first parameter of a drink; and
at least one second group of elements relating to at least one second parameter of a drink;
the at least one second parameter being different from the first parameter;
b) use, by a control unit of the beverage maker, of a selection of at least one element in the first group and of a selection of at least one element in the at least one second group for a decision as to which drink is dispensed by the beverage maker, and
c) determination, by the control unit of the beverage maker, on the basis of a selection of at least one element in the first group and on the basis of a matrix stored in the data memory of the beverage maker, of whether the display of at least one element of the at least one second group on the graphic user interface is changed, the matrix comprising information about whether an element of the first group has a connection to an element of the at least one second group.

9. Method according to claim 8, wherein the first and/or second parameter of the drink is selected from the group consisting of
i) drink type;
ii) drink size;
iii) drink preparation type;
iv) user type;
v) user preferences;
vi) ingredient;
vii) drink price;
viii) country selection; and
ix) menu language.

10. Method according to claim 8, wherein the elements of the first group of elements and/or the elements of the at least one second group of elements are displayed on the graphic user interface via selection fields, preferably via selection fields which display the elements
i) in at least one specific form, preferably a form selected from the group consisting of word(s), number(s), symbol(s) and combinations hereof, particularly preferably in a pictogram; and/or
ii) in at least one specific arrangement, preferably an arrangement selected from the group consisting of slide bar, scroll wheel, individual keys, lists and combinations hereof.

11. Method according to claim 8, wherein a trigger field for preparing a drink is displayed on the graphic user interface and allows a user to select it, preferably a trigger field which comprises at least
i) a word; and/or
ii) a button symbol, preferably a start button symbol; and/or
iii) a symbol of a drink selected by the user;
or consists thereof, the trigger field being preferably configured, after activation by a user, to change its content and/or to send a signal.

12. Method according to claim 8, wherein, via the control unit of the beverage maker, a selection of at least one element in the first group is stored in the data memory such that the selection is preselected after switching off and switching on of the beverage maker, and the display of at least one element of the at least one second group on the graphic user interface is determined, the first parameter being selected preferably for this purpose from the group consisting of country selection, menu language and combinations hereof.

13. Method according to claim 8, wherein, via the control unit of the beverage maker, a selection of at least one element in the first group and a selection of at least one element in the at least one second group is used for the purpose of storing a favourites matrix in the data memory, which matrix comprises information about whether an element of the first group has a connection preferred by a user to an element of the at least one second group and, preferably, via the control unit of the beverage maker, on the basis of a selection of at least one element in the first group and in addition on the basis of the favourites matrix stored in the data memory, it is determined whether the display of at least one element of the at least one second group on the graphic user interface is highlighted or is moved into the background.

14. Method according to claim 8, wherein, via the control unit of the beverage maker, the display of at least one element of the at least one second group on the graphic user interface is moved into the background and/or is highlighted via a change selected from the group consisting of
i) inverse display, greying out, fading out, reducing in size and combinations hereof; and/or
ii) underlined display, colouring, enlarging and combinations hereof.
